(19) United States
(12) Patent Application Publication
(10) Pub. No.: US 2006/0222791 A1
(43) Pub. Date: Oct. 5, 2006

(54) Moisture-permeable dehumidifying capsule

(76) Inventor: Tsang-Hung Hsu, Taoyuan (TW)

Correspondence Address: Tsang-Hung Hsu, P. O. Box 55-846, Taipei, 104, TW

(21) Appl. No.: 11/095,818

(22) Filed: Apr. 1, 2005

(51) Int. Cl. B28B 11/00

(52) U.S. Cl. 428/34.4

(57) ABSTRACT

A moisture-permeable dehumidifying capsule includes a porous container made of porous ceramic shell to permeate moisture-laden air through the porous ceramic shell into the container, and a dehydrating agent filled in the porous container for absorbing moisture as existing in the air and permeated into the container through the porous shell, whereby upon saturation of moisture by the dehydrating agent as filled in the container, the capsule may be easily regenerated by directly placing the capsule in an oven for vaporizing the moisture from the dehydrating agent for removing the moisture as permeably discharged through the porous ceramic shell for conveniently regenerating the dehumidifying capsule.

### BACKGROUND OF THE INVENTION

U.S. Pat. No. 6,675,492 issued to the same inventor of this application disclosed a regenerative dehumidifier including a housing formed with a plurality of perforations through the housing for directing moisture-laden air therein, and a moisture-absorbable dehydrating agent filled in the housing for absorbing moisture laden in the air entering the housing for dehumidification. However, this prior art still has the following drawbacks:
1. The housing should be formed or drilled with many perforations through the housing wall, increasing production complexity and cost.
2. For preventing outward releasing of the granular dehydrating agent through the perforations in the housing, an air-permeable filter sheet (21) should be attached to the inside surface of the covers (11, 12) of the housing (1), thereby increasing the production and maintenance inconvenience of the dehumidifier.

The present inventor has found the drawbacks of the prior art and invented the present dehumidifying capsule.

### SUMMARY OF THE INVENTION

The object of the present invention is to provide a moisture-permeable dehumidifying capsule including a porous container made of porous ceramic shell to permeate moisture-laden air through the porous ceramic shell into the container, and a dehydrating agent filled in the porous container for absorbing moisture as existing in the air and permeated into the container through the porous shell, whereby upon saturation of moisture by the dehydrating agent as filled in the container, the capsule may be easily regenerated by directly placing the capsule in an oven for vaporizing the moisture from the dehydrating agent for removing the moisture as permeably discharged through the porous ceramic shell for conveniently regenerating the dehumidifying capsule.

### BRIEF DESCRIPTION OF THE DRAWINGS

FIG. 1 is a sectional drawing of the dehumidifying capsule of the present invention.

FIG. 2 is an illustration showing a saturation indicator formed on the capsule of the present invention.

FIG. 3 is an illustration of the capsule of the present invention when mounted on a holding base.

FIG. 4 shows a modification of the holding base of the capsule of the present invention.

FIG. 5 shows another modification of the holding base of the capsule of the present invention.

### DETAILED DESCRIPTION

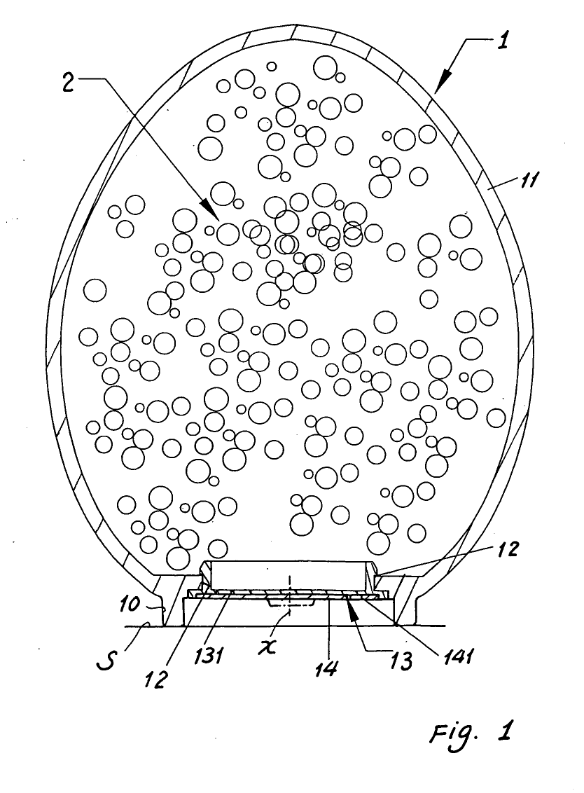

As shown in FIG. 1, a dehumidifying capsule of the present invention comprises: a porous container 1, and a moisture-absorbable dehydrating agent 2 filled in the container 1.

The porous container 1 is formed with porous ceramic shell 11 which is air and moisture permeable through the shell 11 so that the moisture-laden air may be permeated into the container 1 through the porous ceramic shell 11 to be dehumidified by the dehydrating agent 2 as filled in the container 1.

The dehydrating agent 2 may be selected from silica gel or any other moisture-absorbable materials, not limited in this invention.

The porous container 1 is no longer drilled with perforations or ventilation holes through the shell 11 since the shell 11 is air and moisture permeable or penetrable. So, the granular dehydrating agent 2 as filled in the container 2 will not be released outwardly since the porosity in the shell 11 is too fine, thereby preventing unexpected outward releasing of the granular dehydrating agent 2 from the interior of the container 1. Therefore, a filter sheet (21) as provided in U.S. Pat. No. 6,675,492 to preclude the outward releasing of the granular dehydrating agent 2 may now be eliminated to thereby save production cost and to thereby enhance the maintenance convenience.

The porous container 1 includes an opening 12 formed in the container for filling or re-filling the dehydrating agent 2 into the container 1 through the opening 12, and a plug 13 which may be plugged in the opening 12 for sealing the opening 12 once the container 1 is fully or well filled with the dehydrating agent 2 therein.

The plug 13 may further include a plug hole 131 formed through the plug 13, and a cover 14 movably or rotatably engaged on the plug 13 for normally closing the plug hole 131 and having a cover hole 14 formed through the cover 14 to be operatively communicated with the plug hole 131 in the plug 13 when rotating the cover 14 for matching the cover hole 141 with the plug hole 131.

By the way, when the cover 14 normally closes the plug hole 131 in the plug 13, the moisture as laden in the air may permeate into the container through the porous shell 11 to be absorbed by the dehydrating agent 2 in the container 1 for dehumidifying the air surrounding the capsule of the present invention.

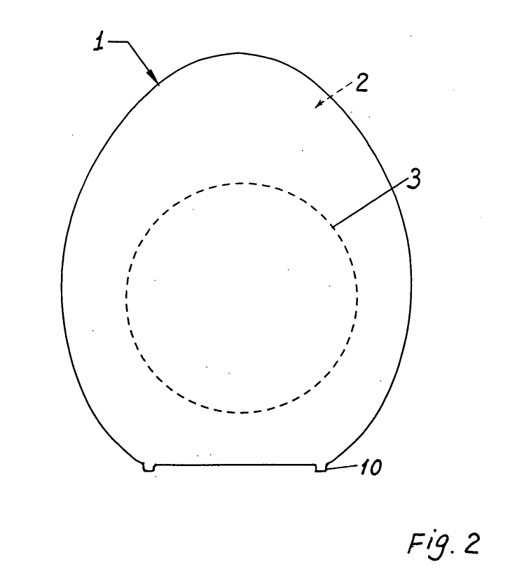

A saturation indicator 3 such as a color-change indicator (e.g., cobalt chloride) impregnated in the dehydrating agent may be coated, printed or formed on the capsule 1 as shown in FIG. 2. Upon saturation of moisture by the dehydrating agent in the container 1, the saturation indicator 3 may be subjected to a color change (such as from blue color to red color) to remind the user for regenerating the dehydrating agent 2 in the container 1.

Since the container 1 is formed with porous shell 11 such as formed with porous ceramic material, the capsule 1 may be directly placed in an oven (such as a microwave oven) to be heated for vaporizing the moisture as saturated in the dehydrating agent 2 and the vaporized moisture will be released or discharged outwardly through the porous shell 11 for regenerating the dehydrating agent 2 for its re-use.

During the regeneration of the dehydrating agent 2 in the container 1, the cover 14 may be moved or rotated about the longitudinal axis X at a center of the cover 14 and the plug 13 to coincide the cover hole 141 with the plug hole 131 to allow a rapid outward releasing of water vapor as vaporized from the saturated moisture as absorbed by the dehydrating agent when heated. Preferably, the capsule as shown in FIG. 1 may be inverted or laid down in an oven to orient the holes 131, 141 upwardly or inclinedly to quickly vaporize the moisture for accelerating the regeneration operation.

The container 1 may be formed with a plurality of supporting legs 10 on the container bottom portion to be rested on a supporting surface S.

The container 1 may be formed as an egg, oval, spherical or cylindrical shape, but not limited in the present invention.

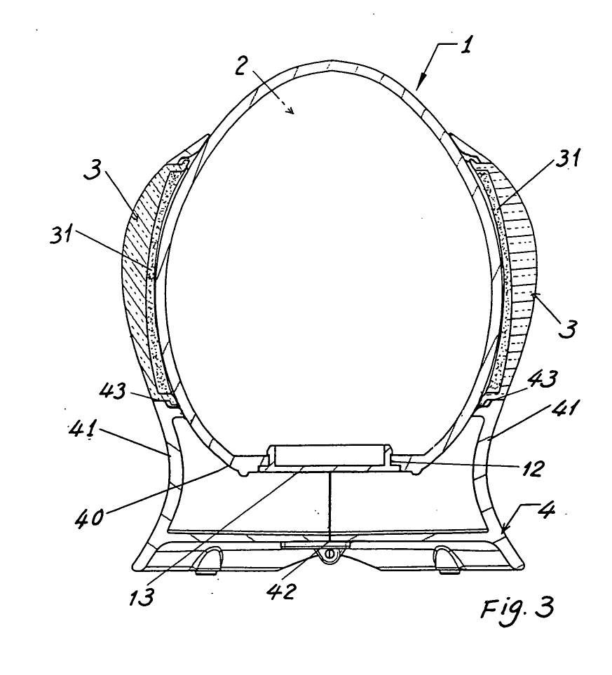

As shown in FIGS. 3˜5, a holding base 4 is provided for mounting, supporting or resting the porous container 1 on the base 4. The base 4 is not so critical in this invention. However, the capsule, once being held on the base 4, will be more stable and better decorative.

As shown in FIG. 3, the holding base 4 includes: a pair of holding arms 41 combinably pivotally assembled (by a hinge 42) for detachably clamping or holding the porous container 1 in a socket 40 recessed in a central portion of the base 4.

Each holding arm 41 may be embedded with the saturation indicator 3 in a display window 43 formed in the holding arm 41 for showing a color change of the saturation indicator 3 when the dehydrating agent 2 in the container 1 is saturated by moisture. Each saturation indicator 3 has the color-change indicator 31 impregnated in the dehydrating agent and filled in the indicator 3 as shown in FIG. 3.

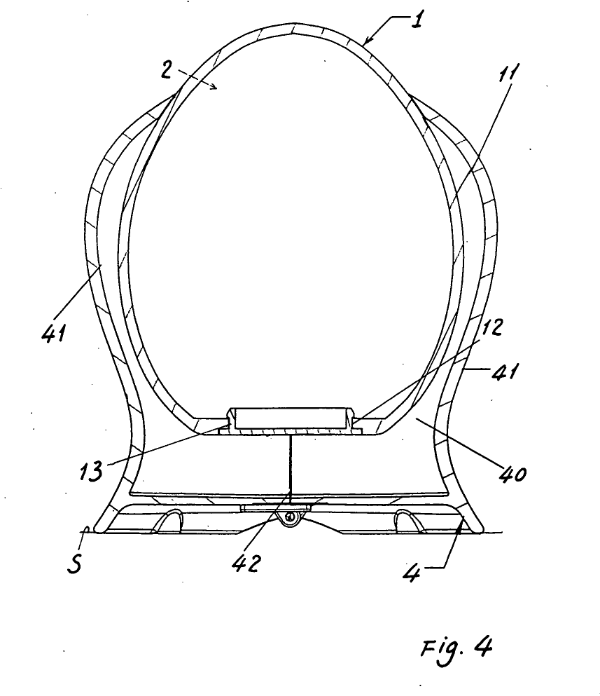

The holding base 4 is simplified from FIG. 3 to FIG. 4, such as by simplifying the saturation indicator to be simply coated or printed on the base 4 or on other suitable locations.

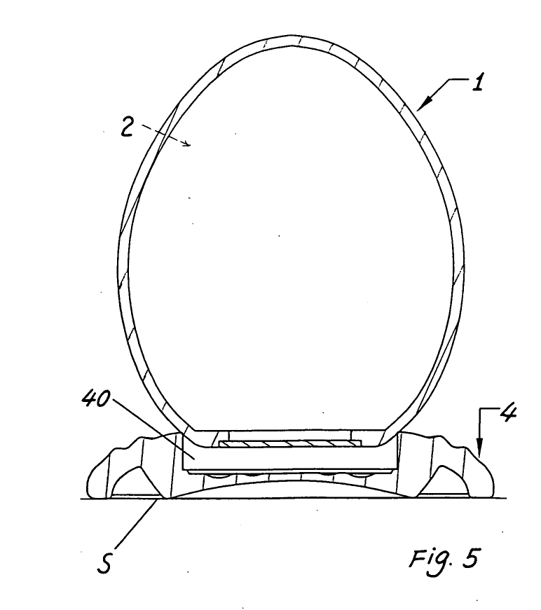

In FIG. 5, the holding base 4 is further simplified to eliminate the two holding arms 41 as previously mentioned. The container 1 is then rested on the simple holding base 4.

The present invention provides a compact dehumidifier which may allow the moisture penetrable through the porous ceramic shell 11 into the container for simplifying the operation and production thereof. For regeneration, it may be directly placed in an oven for heating, quickly vaporizing and releasing the moisture through the porous shell.

Nevertheless, the present invention may be further modified without departing from the spirit and scope of the present invention.

I claim:

1. A dehumidifying capsule comprising:
a porous container formed with porous ceramic shell which is air and moisture permeable through the shell; and
a dehydrating agent filled in said porous container for absorbing moisture laden or existing in the air as permeated into said container through said porous ceramic shell, whereby upon saturation of said dehydrating agent by saturatedly absorbing the moisture, said porous container is heated to vaporize the moisture as absorbed by said dehydrating agent to directly release moisture vapor outwardly through the porous ceramic shell for conveniently regenerating the capsule.

2. A dehumidifying capsule according to claim 1, wherein said porous container is formed with an opening therein for filling said dehydrating agent into said container through said opening.

3. A dehumidifying capsule according to claim 2, wherein said container further includes a plug for closing said opening in said container for normally absorbing moisture permeated into said container by said dehydrating agent in said container.

4. A dehumidifying capsule according to claim 3, wherein said plug includes a cover movably engaged on said plug; said plug having a plug hole formed in said plug; and said cover having a cover hole formed in said cover; said cover normally closing said plug hole; and upon coinciding of said cover hole with said plug hole, the moisture in said dehydrating agent in said container will be rapidly vaporized outwardly through said plug hole and said cover hole for quickly regenerating the capsule.

5. A dehumidifying capsule according to claim 1, wherein said container includes a plurality of supporting legs formed on said container for supporting said container.

6. A dehumidifying capsule according to claim 1, wherein said container further includes a saturation indicator formed by impregnating a color-change indicator in a dehydrating agent, with said saturation indicator formed on said container and operatively indicating a saturation of the dehydrating agent by saturatedly absorbing moisture by changing color on the saturation indicator.

7. A dehumidifying capsule according to claim 1, wherein said container further includes a holding base adapted for mounting or resting said container on said holding base.

8. A dehumidifying capsule according to claim 7, wherein said holding base includes a pair of holding arms combinably pivotally assembled for clamping said container within said pair of holding arms.

9. A dehumidifying capsule according to claim 8, wherein said holding base includes a saturation indicator formed thereon for indicating a saturation of a dehydrating agent by saturatedly absorbing moisture from the air.

10. A dehumidifying capsule according to claim 8, wherein one said holding arm has a saturation indicator formed on said holding arm for indicating the saturation of a dehydrating agent by saturatedly absorbing moisture from the air.

11. A dehumidifying capsule according to claim 1, wherein said porous container is formed as an oval shape.
